(19) United States
(12) Patent Application Publication
(10) Pub. No.: US 2026/0322737 A1
(43) Pub. Date: Oct. 15, 2026

(54) AUTOMATING ROUTE TARGET GENERATION IN MULTI-FABRIC NETWORKS

(71) Applicant: HEWLETT PACKARD ENTERPRISE DEVELOPMENT LP, Spring, TX (US)

(72) Inventors: Saumya Dikshit, Bangalore (IN); Venkata Naga Siva Ramaprasad Allu, Bangalore (IN)

(21) Appl. No.: 19/261,414

(22) Filed: Jul. 7, 2025

(30) Foreign Application Priority Data
Apr. 14, 2025 (IN) 202541036017

(51) Int. Cl. H04L 45/74; H04L 12/46

(52) U.S. Cl. CPC H04L 45/74; H04L 12/4641

(57) ABSTRACT

In certain implementations, a network device in a first network fabric includes a network adapter configured to communicate with peer devices in the first network fabric and a second network fabric. The network device includes at least one processing resource and at least one non-transitory machine-readable storage medium storing instructions that when executed by the at least one processing resource cause the network device to identify first routing information to be shared with a first peer device, and determine a first autonomous system (AS) number associated with the first peer device. The instructions when executed by the at least one processing resource further cause the network device to generate a first route target by combining the first AS number with a first virtual network identifier (VNI), incorporate the first route target into a first Border Gateway Protocol (BGP) update message containing the first routing information, and transmit the first BGP update message to the first peer device.

### BACKGROUND

Large-scale networks, such as enterprise networks, may employ multiple interconnected network fabrics to support their operations across different locations, departments, or organizational units. These network fabrics may use Border Gateway Protocol (BGP) to exchange routing information between different autonomous systems (AS), where each AS represents an independent network domain with its own routing policies and control. To manage route distribution and maintain network segmentation, BGP implementations may use route targets, which are extended community attributes that help control which network devices receive and process specific routing information. The exchange of routing information between network fabrics may involve careful management of route targets to maintain proper network segmentation while allowing for controlled communication between intended network domains.

### BRIEF DESCRIPTION OF THE DRAWINGS

Aspects of the present disclosure are best understood from the following detailed description when read with the accompanying figures.

FIG. 1 illustrates an example network device that may generate and manage route targets across multiple network fabrics, according to some implementations.

FIG. 2 illustrates an example implementation of a network device that executes instructions for automatic route target generation and management between network fabrics, according to some implementations.

FIG. 3 illustrates an example network deployment showing multiple network fabrics, where a network device in a new network fabric automatically generates and manages route targets for exchanging routing information with an existing network fabric, according to some implementations.

FIG. 4 illustrates an example network deployment showing multiple network fabrics, where a shared border gateway device automatically generates and manages route targets for exchanging routing information between new network fabrics and existing network fabrics, according to some implementations.

FIG. 5 illustrates an example process for automatically generating and managing route targets in multi-fabric network deployments, according to some implementations.

FIG. 6 illustrates an example method for automatically generating and managing route targets in multi-fabric network deployments, according to some implementations.

FIG. 7 illustrates an example method for automatically generating and managing route targets in multi-fabric network deployments, according to some implementations.

### DESCRIPTION

In large-scale networks, managing route targets between network fabrics of a multi-fabric network may present significant technical challenges, particularly when adding new network fabrics to existing deployments. Traditional approaches may require manual configuration of existing network devices in the deployed fabrics to maintain proper network segmentation while allowing controlled communication between different autonomous systems (AS). This manual network device configuration may become increasingly complex and error-prone in heterogeneous networks where network devices from multiple vendors coexist, especially during network transitions or expansions where network fabrics may share common border devices. A solution is needed that allows network devices in newly added network fabrics to dynamically generate and manage route targets based on AS numbers of BGP peers (e.g., network devices that use Border Gateway Protocol (BGP) for exchanging routing information between different autonomous systems (AS)) without requiring configuration changes to the existing network devices in the deployed fabrics.

Certain implementations of this disclosure provide a technical solution for automatically generating and managing route targets in multi-fabric deployments. The solution may enhance interoperability between different vendor devices while minimizing configuration complexity. For example, in a first step, when a network device in a newly-added network fabric identifies routing information to be shared with a peer (either within the same network fabric or in an existing network fabric), the network device may check the AS configuration of that peer. In a second step, the network device may automatically generate route targets by combining the peer's AS number with the relevant VNI configured for that network segment. In a third step, the network device may incorporate these automatically generated route targets into the routing information as extended community attributes and transforms them based on whether the peer is internal to the network fabric or external to the network fabric, and based on the peer's specific VNI configuration. In a fourth step, the network device constructs and sends a BGP update message containing the routing information and transformed route targets to the peer. This may allow routes to be properly tagged for absorption by the intended recipients without requiring manual configuration or changes to the network devices within the newly added fabric or the existing fabrics.

Other implementations of this disclosure provide a technical solution for automatically generating different route targets when different VNIs are configured for the same virtual local area network (VLAN) across different peers. For example, in a first step, a network device in a newly added network fabric may identify that a VLAN is to be advertised with different VNIs to different peers, and the network device may determine whether each peer is internal to the newly added fabric or in an existing fabric. In a second step, for peers within the same newly added fabric, the network device may generate route targets using one VNI, while for peers in existing fabrics, it may generate route targets using a different VNI. In a third step, the network device may incorporate the appropriate route targets into separate BGP update messages for internal and external peers by combining the respective AS numbers with their corresponding VNIs. In a fourth step, the network device may send the separate BGP update messages to their respective peers.

The solution for managing route targets in a multi-fabric network deployment may be implemented in the control plane of a network device. In an implementation, the network device may function as a border gateway device, route reflector, route server, or switch. The multi-fabric network deployment may be a heterogeneous network in which network devices from multiple vendors coexist. These network devices may be deployed in overlay networks formed using tunneling protocols and various virtual private network (VPN) technologies such as Ethernet VPN (EVPN), Layer 3 VPN (L3VPN), Layer 2 VPN (L2VPN) over Virtual Extensible LAN (VXLAN) or Multiprotocol Label Switching (MPLS) fabrics. Network devices in these overlay networks may act as tunnel endpoints, encapsulating and forwarding packets via tunnels based on corresponding network identifiers. Network fabrics, which are collections of interconnected network devices operating as unified systems, may support various virtual private network (VPN) technologies while maintaining interoperability between equipment from multiple vendors, particularly when additional network fabrics with new network devices are added to existing deployments or when multiple network fabrics share common border devices during network transitions or expansions. The network device may check the AS configuration of its BGP peers and automatically generate appropriate route targets that align with the peers' AS numbers and Virtual Network Identifiers (VNIs). In an implementation, the route target generation can be configured globally for multiple (and possibly all) peers or specifically for individual peers or peer groups, including scenarios where border devices are shared between multiple network fabrics.

Certain implementations of this disclosure may provide one or more technical advantages. For example, certain implementations provide techniques for automatically generating and managing route targets in multi-fabric deployments, which may allow new network fabrics to be added to existing deployments without requiring manual configuration changes or downtime to the existing network devices. By using these techniques, network devices in newly added fabrics can dynamically manage route targets based on their peers' AS configurations, significantly reducing the complexity of multi-fabric deployments. Each network device can utilize these techniques independently without requiring additional control plane exchange between BGP peers, allowing for proper route exchange between fabrics while maintaining network segmentation. This may be particularly valuable in deployments where peers may number in the hundreds and VLANs may number in the thousands. These implementations may simplify configuration complexity for both internal and external fabric BGP peers, and may support cost-effective deployments where border devices are shared between multiple fabrics. These implementations may work with different virtual private network (VPN) technologies including EVPN, L3VPN, and L2VPN that use BGP control plane, which may allow for integration of new fabrics with existing network infrastructure from different vendors. Further, the ability to work with existing devices without requiring manual configuration changes may result in lower operational costs and reduced deployment complexity.

In this disclosure, if a network device facilitates communication between network fabrics, the network device can be referred to as a “border device” or “border gateway device”. Any physical or virtual device (e.g., a virtual machine or switch operating on a computing device) that can forward traffic to an end device can be referred to as a “network device.” These network devices may function as border gateway devices, route reflectors, route servers, or switches within network fabrics. Additionally, the term “packet” refers to a group of bits that can be transported together across a network. “Packet” should not be interpreted as limiting examples of the present disclosure to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

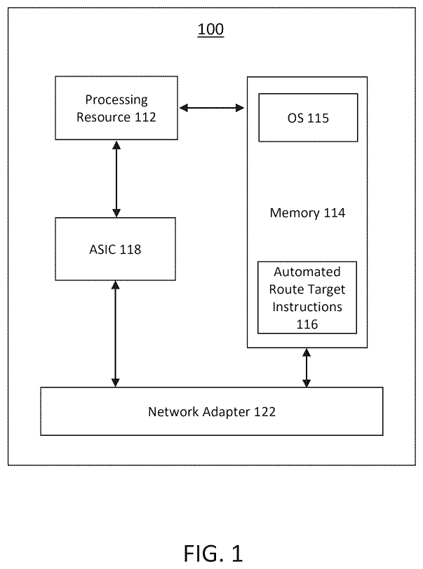

FIG. 1 illustrates an example network device 100 that may generate and manage route targets across multiple network fabrics. In an implementation, the network device 100 may be part of a new network fabric being added to existing network fabrics during network transitions or expansions. In an implementation, the network device 100 may generate and manage route targets to facilitate exchange of routing information between the new network fabric and existing network fabrics without requiring configuration changes to existing network devices in the existing network fabrics. The network device 100 may operate in networks comprising network devices from different vendors. For example, the network device 100 in the new network fabric may be from a first vendor while the network devices in the existing network fabrics may be from vendors different from the first vendor.

The network device 100 may be part of a first network fabric (e.g., the new network fabric), and the network device 100 may include a network adapter 122 having multiple communication ports that provide inter-device communication channels for exchanging routing information with peer devices in the first network fabric, and with peer devices in other network fabrics (e.g., the existing network fabrics). The communication ports may allow network communications using various networking protocols. A respective port may operate as an ingress port for receiving packets or as an egress port for transmitting packets. In an implementation, the network adapter 122 may allow the network device 100 to function as a border gateway device that allows for communication between the first network fabric and the other network fabrics without requiring configuration changes to the network devices of the other network fabrics. In an implementation, the network adapter 122 may support various networking technologies suitable for fabric interconnection, including high-speed network interfaces that enable the exchange of BGP update messages containing route target information between the network device 100 and peer devices across different network fabrics.

In an implementation, the network device 100 may include at least one processing resource 112 that may perform a variety of operations such as executing routing processes for BGP operations, generating and managing route targets, and processing routing information exchanged between the network device 100 and peer devices of the first network fabric and between the network device 100 and peer devices of the other network fabrics. The at least one processing resource 112 may include one or more programmable logic devices, microprocessors, application-specific integrated circuits (ASICs), controllers, or any other suitable computing devices or resources or any combination of the preceding. In certain implementations, the at least one processing resource 112 may be or may include a central processing unit (CPU).

In an implementation, the network device 100 may include memory 114, which may include at least one non-transitory machine readable medium that stores automated route target instructions 116 for execution by the at least one processing resource 112. The memory 114 may provide temporary storage for data and instructions actively used by the at least one processing resource 112. This may include routing information to be exchanged with peer devices, AS numbers associated with the peer devices, VNI configurations for the first network fabric and other network fabrics, and the automated route target instructions 116 (described subsequently) for generating and managing route targets. In certain implementations, the memory 114 may store BGP update messages before they are processed by the at least one processing resource 112 or transmitted to peer devices via the network adapter 122.

In an implementation, the network device 100 may include an application-specific integrated circuit (ASIC) 118 dedicated to data plane operations including packet processing and forwarding. The ASIC 118 may process received packets to determine how to forward them, and may determine which communication ports to use for transmitting packets. In an implementation, the ASIC 118 may receive packets from and transmit packets to peer devices through the network adapter 122. In an implementation in which the at least one processing resource 112 includes an ASIC, these same packet processing and forwarding operations may be performed by the at least one processing resource 112 without requiring the ASIC 118, As such, while the ASIC 118 and the at least one processing resource 112 are illustrated separately, their functions may be combined into a single component or further subdivided across multiple components in any suitable manner.

In an implementation, the memory 114 may store automated route target instructions 116 (which may also be referred to subsequently as programming) that, when executed by the at least one processing resource 112, cause the network device 100 to generate and manage route targets. When executed, the automated route target instructions 116 cause the at least one processing resource 112 to: combine AS numbers with VNIs to generate route targets, create appropriate route targets for different peer devices, transform these route targets based on whether the peer device is internal to the first network fabric or in other network fabrics, and incorporate these route targets into BGP update messages. The automated route target instructions 116, when executed, may further cause the at least one processing resource 112 to gather AS numbers and VNI configurations for route target generation. In addition, the at least one processing resource 112 may execute the automated route target instructions 116 to interact with the network adapter 122 for exchanging the BGP update messages with peer devices across the network fabrics.

In an implementation, the network device 100 may include an operating system (OS) 115 stored in the memory 114. The OS 115 may control hardware resources and provide services for the at least one processing resource 112 and other components of the network device 100. The OS 115 may be a vendor-specific network operating system that is different from the operating systems of network devices from other vendors. In an implementation, the OS 115 may process routing information and handles route targets in ways that differ from operating systems of network devices from other vendors. For example, when the network device 100 is from the first vendor, the OS 115 may be a first type of network operating system that processes route targets differently from network operating systems used by network devices from different vendors in the existing network fabrics.

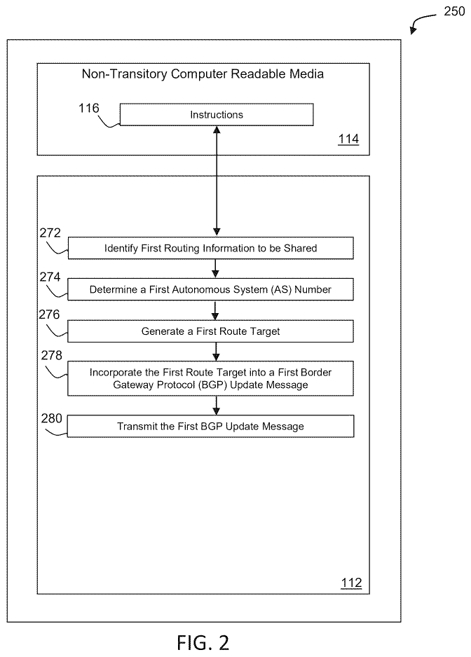

FIG. 2 depicts an example implementation of a network device 250 that can utilize processes disclosed herein. The network device 250 may be an instance of the network device 100 described previously in FIG. 1. Further details of the process are provided in FIG. 2.

As shown in FIG. 2, the network device 250 comprises at least one processing resource 112 and one or more non-transitory machine readable medium (e.g., the memory 114) storing automated route target instructions 116 for execution by the at least one processing resource 112. The automated route target instructions 116 may comprise instructions 272-280, where each numbered instruction represents a different set of instructions. Instructions 272 may comprise instructions to identify first routing information to be shared with a first peer device. Instructions 274 may comprise instructions to determine a first autonomous system (AS) number associated with the first peer device. Instructions 276 may comprise instructions to generate a first route target by combining the first AS number with a first virtual network identifier (VNI). Instructions 278 may comprise instructions to incorporate the first route target into a first Border Gateway Protocol (BGP) update message containing the first routing information. Instructions 280 may comprise instructions to transmit the first BGP update message to the first peer device.

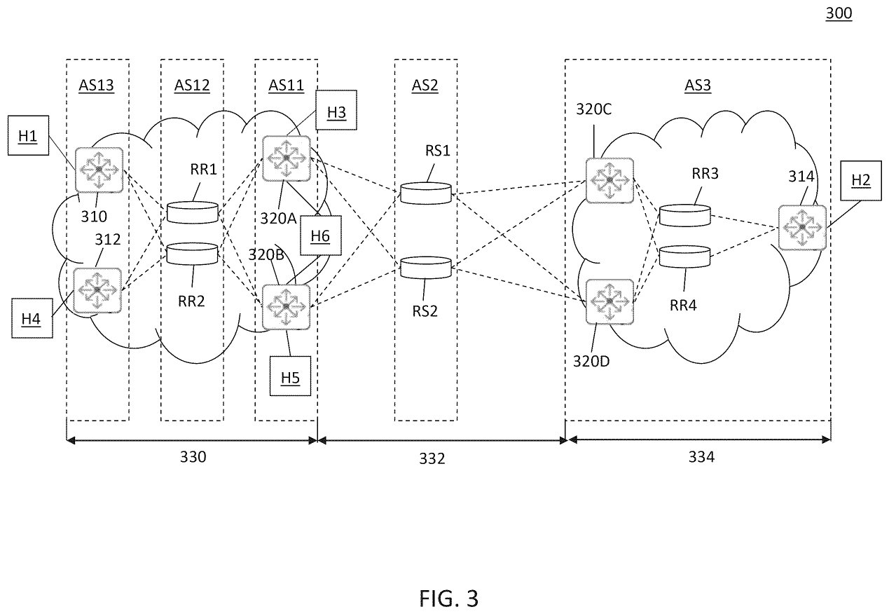

FIG. 3 illustrates an example network deployment 300 showing multiple network fabrics with different autonomous systems (AS). In an implementation, the network deployment 300 may include any number of network fabrics, and each of these network fabrics may span any number of autonomous systems (AS). The network deployment 300 may include a network fabric 330 spanning autonomous systems AS13, AS12, and AS11, a WAN (Wide Area Network) portion 332 operating in autonomous system AS2, and a network fabric 334 operating in autonomous system AS3. In an implementation, the network fabric 334 may be an existing network fabric deployment, while the network fabric 330 may be a new network fabric being added to the network deployment 300 during a network transition or expansion. In an implementation, one or more network devices in the network fabric 330 may be from a first vendor, while one or more network devices in the existing network fabric 334 may be from vendors different from the first vendor. The network fabric 330 may facilitate route target generation and management that allows for exchange of routing information with the existing network fabric 334 without requiring configuration changes to existing network devices in the network fabric 334. The WAN portion 332 may provide connectivity between the network fabrics 330 and 334, enabling communication between, for example, different geographical locations. The WAN portion 332 may operate in autonomous system AS2, and may include route servers RS1 and RS2, which may be network devices that facilitate the exchange of routing information between the network fabrics 330 and 334. The route servers RS1 and RS2 may act as intermediaries, receiving BGP update messages from border gateway devices 320A and 320B (described subsequently) in the network fabric 330 and forwarding them to border gateway devices 320C and 320D in the network fabric 334. For example, when the network fabric 330 needs to communicate with the network fabric 334, routing information may be exchanged through the WAN portion 332, where the route servers RS1 and RS2 handle the distribution of routes and ensure proper routing between the autonomous systems of the networks 330 and 334.

In an implementation, the network fabric 330 may include leaf switches 310 and 312, which are network devices that may function as Virtual Tunnel Endpoints (VTEPs) that have the capability to encapsulate and decapsulate packets within a Virtual Extensible LAN (VXLAN) network. In addition, the network fabric 334 may include a leaf switch 314, which may be a network device that functions as a VTEP. The leaf switches 310, 312, and 314 may connect to hosts. For example, the leaf switch 310 may connect to a host H1, the leaf switch 312 may connect to a host H4, and the leaf switch 314 may connect to a host H2. The hosts H1, H4, and H2 may be user or client devices such as laptops, desktops, printers, cellphones, tablets, IoT devices, or appliances. The hosts H1, H4, and H2 may need to be authenticated to connect to their respective network fabrics, and upon successful authentication, may be allocated to specific VLANs based on their host types. The leaf switches 310, 312, and 314 may provide the first point of entry for the respective hosts H1, H4, and H2 into their respective network fabrics. In the VXLAN network, each VLAN may be associated with a unique Virtual Network Identifier (VNI), and the VTEPs may use these VNIs when encapsulating packets for transmission across the network fabrics. In an implementation, different VNIs may be configured for the same VLAN when communicating with different peer devices across the network fabrics.

In an implementation, the network fabric 330 may also include border gateway devices 320A and 320B. The border gateway devices 320A and 320B may be network devices that function as VTEPs. The border gateway device 320A may connect to hosts H3 and H6, and the border gateway device 320B may connect to hosts H5 and H6. In addition, the network fabric 334 may include border gateway devices 320C and 320D. The border gateway devices 320C and 320D are network devices that may also function as VTEPs. The border gateway devices 320A, 320B, 320C, and 320D may handle tunnel stitching between network fabrics 330 and 334 through the WAN portion 332. The hosts H3, H5, and H6 may be similar to the hosts H1, H4, and H2 that were described above.

In an implementation, the network fabric 330 may include route reflectors RR1 and RR2, which may be network devices that facilitate the distribution of routing information within the network fabric 330. The route reflectors RR1 and RR2 may operate within autonomous systems AS13, AS12, and AS11, by for example, receiving BGP update messages from the leaf switches 310 and 312 and the border gateway devices 320A and 320B, and reflecting these messages to other network devices within the network fabric 330. In addition, the network fabric 334 may include route reflectors RR3 and RR4, which may be network devices that facilitate the distribution of routing information within the autonomous system AS3.

In an implementation, network devices in the network fabric 330, such as the border gateway devices 320A and 320B, and the route reflectors RR1 and RR2, as well as the route servers RS1 and RS2 in the WAN portion 332, may each be configured as instances of the network device 100 described previously in FIG. 1. These network devices may rewrite or generate route targets in BGP update messages based on peer device configurations. For example, when forwarding messages between the network fabric 330 and the network fabric 334, these network devices may modify or generate the route targets to ensure proper route absorption by the receiving devices. For example, the route servers RS1 and RS2 may modify or generate route targets when forwarding messages between the border gateway devices 320A and 320B of the network 330, while the route reflectors RR1 and RR2 may modify or generate route targets when forwarding messages between the border gateway devices 320A and 320B and the leaf switches 310 and 312 within the network fabric 330.

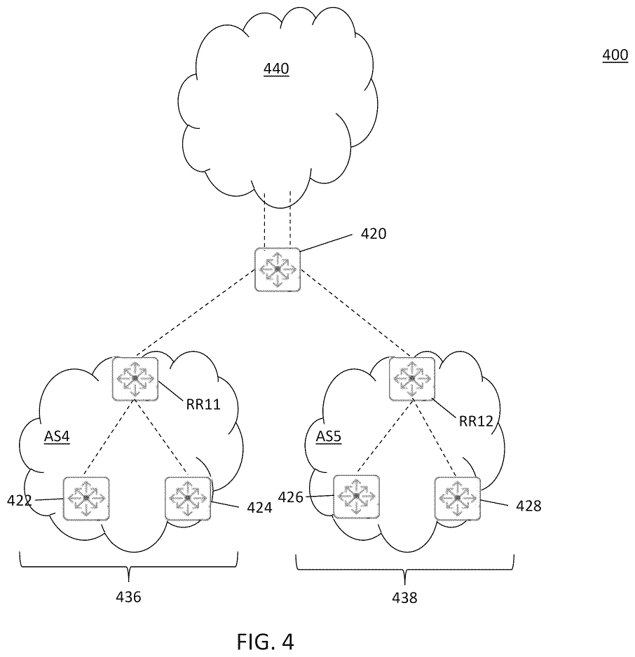

FIG. 4 illustrates an example network deployment 400 showing multiple network fabrics with different autonomous systems (AS). In an implementation, the network deployment 400 may include any number of network fabrics, and each of these network fabrics may span any number of autonomous systems. The network deployment 400 may include a network fabric 436 operating in autonomous system AS4, a network fabric 438 operating in autonomous system AS5, and a portion 440 that may represent a full mesh of network fabrics and border BGP peers. The full mesh of network fabrics in portion 440 may represent multiple existing network fabrics at different sites, each with their own border BGP peers. These remote network fabrics may be interconnected in a mesh topology, allowing for direct communication paths between different sites. In an implementation, one or more of the network fabrics (e.g., the network fabric 436 and/or the network fabric 438) may be a new network fabric being added to an existing deployment that may include the other network fabric (e.g., the network fabric 436 or the network fabric 438) and the full mesh of network fabrics in portion 440. In an implementation, one or more network devices in the new network fabric (e.g., the network fabric 436 and/or the network fabric 438) may be from a first vendor, while one or more network devices in the existing network fabric (e.g., the network fabric 436 or the network fabric 438 and the full mesh of network fabrics in portion 440) may be from vendors different from the first vendor. The new network fabric (e.g., the network fabric 436 and/or the network fabric 438) may facilitate route target generation and management that allows for exchange of routing information with the existing network fabric (e.g., the network fabric 436 or the network fabric 438 and the full mesh of network fabrics in portion 440) without requiring configuration changes to existing network devices in the existing network fabric (e.g., the network fabric 436 or the network fabric 438 and the full mesh of network fabrics in portion 440).

In an implementation, the network deployment 400 may include a shared border gateway device 420 that may be shared between the network fabric 436 and the network fabric 438. In an implementation, the shared border gateway device 420 may be shared between any number of network fabrics. The shared border gateway device 420 may handle routing information exchange between network fabrics 436 and 438, and with the full mesh of network fabrics in portion 440. The shared border gateway device 420 may be a network device that may also function as a VTEP. The shared border gateway device 420 may connect to portion 440 through WAN uplinks. The WAN uplinks may be high-speed network connections that enable communication between network fabrics that are, for example, in different geographic locations. The WAN uplinks may provide dedicated paths for exchanging routing information and network traffic between network fabrics. The network fabric 436 may include leaf switches 422 and 424 that operate as VTEPs. The network fabric 436 may also include a route reflector RR11, which may be a network device that facilitates the distribution of routing information within the network fabric 436. The route reflector RR11 may operate within autonomous system AS4, by for example, receiving BGP update messages from the leaf switches 422 and 424 and the shared border gateway device 420, and reflecting these messages to other network devices within the network fabric 436. In addition, the network fabric 438 may include leaf switches 426 and 428 that operate as VTEPs. The network fabric 438 may also include a route reflector RR12, which may be a network device that facilitates the distribution of routing information within the network fabric 438. The route reflector RR12 may operate within autonomous system AS5, by for example, receiving BGP update messages from the leaf switches 426 and 428 and the shared border gateway device 420, and reflecting these messages to other network devices within the network fabric 438.

The network deployment 400 may utilize different types of BGP sessions for different communication paths. Internal BGP (IBGP) sessions may be established between the leaf switches and route reflectors within each network fabric. For example, in the network fabric 436, leaf switches 422 and 424 may use IBGP to communicate with route reflector RR11, while in the network fabric 438, leaf switches 426 and 428 may use IBGP to communicate with route reflector RR12. External BGP (EBGP) sessions may be used for communication between autonomous systems, such as between the shared border gateway device 420 and the network fabrics 436 and 438, as well as with the full mesh of network fabrics in portion 440.

In an implementation, the shared border gateway device 420 and the route reflectors RR11 and RR12 may each be configured as instances of the network device 100 described previously in FIG. 1. The shared border gateway device 420 and the route reflectors RR11 and RR12 may rewrite or generate route targets in BGP update messages based on peer device configurations. For example, when forwarding messages between the network fabric 436 and the network fabric 438, between the network fabric 436 and the full mesh of network fabrics in portion 440, and between the network fabric 438 and the full mesh of network fabrics in portion 440, the shared border gateway device 420 and the route reflectors RR11 and RR12 may modify or generate route targets to ensure proper route absorption by the receiving devices. The route reflector RR11 may modify or generate route targets when forwarding messages between the shared border gateway device 420 and the leaf switches 422 and 424 within the network fabric 436. In addition, the route reflector RR12 may modify or generate route targets when forwarding messages between the shared border gateway device 420 and the leaf switches 426 and 428 within the network fabric 438.

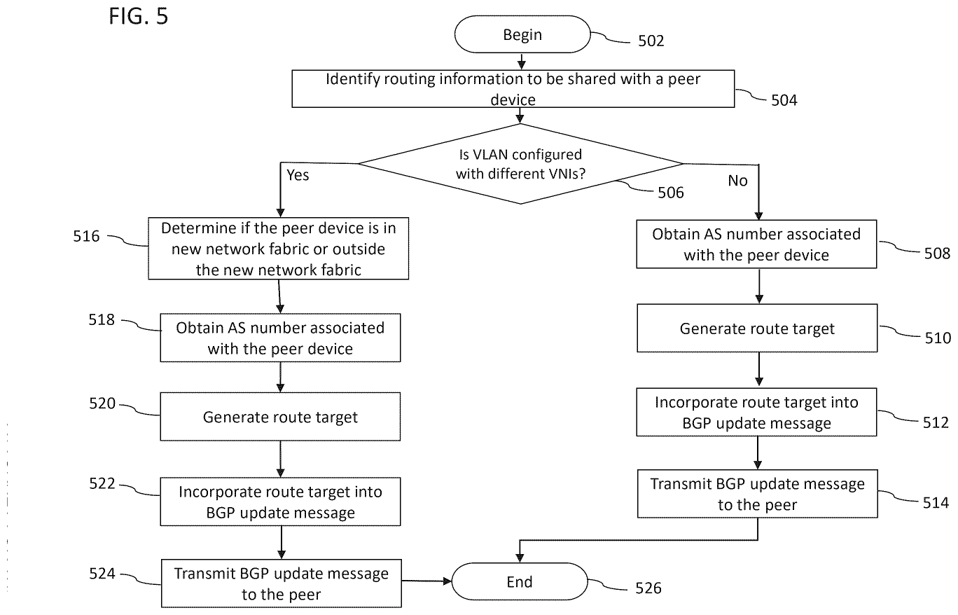

FIG. 5 illustrates a flowchart 500 of a process for automatically generating and managing route targets in multi-fabric network deployments. The route target generation process may allow for the exchange of routing information between network fabrics such as, for example, when new network fabrics are being added to existing network fabrics during network transitions or expansions. The process depicted in FIG. 5 may be performed using the components described in FIG. 1, and may be implemented in network deployments such as the network deployment 300 illustrated in FIG. 3 (e.g., between the network fabric 330 as the new network fabric and the network fabric 334 as the existing network fabric), and the network deployment 400 illustrated in FIG. 4 (e.g., where one or more of the network fabrics 436 and 438 may be the new network fabric being added to an existing deployment that may include the other network fabric and the full mesh of network fabrics in portion 440). In an implementation, one or more network devices (e.g., the border gateway devices 320A and 320B and route reflectors RR1 and RR2 in the network fabric 330, or the shared border gateway device 420 and route reflectors RR11 and RR12 in the network fabrics 436 and 438) in the new network fabric may be from a first vendor, while one or more network devices in the existing network fabric may be from vendors different from the first vendor. The one or more network devices in the new network fabric may be configured as instances of the network device 100 described in FIG. 1. In an implementation, the one or more network devices in the new network fabric from the first vendor may operate with the operating system (OS) 115 (described previously in FIG. 1), while the one or more network devices in the existing network fabric from vendors different from the first vendor may operate with operating systems that are different from the operating system (OS) 115. The new network fabric may facilitate route target generation and management that allows for exchange of routing information with the existing network fabric without requiring configuration changes to existing network devices in the existing network fabric.

Step 502 marks the beginning of the route target generation process. One or more network devices in the new network fabric (e.g., the border gateway devices 320A and 320B and route reflectors RR1 and RR2 in the network fabric 330, or the shared border gateway device 420 and route reflectors RR11 and RR12 in the network fabrics 436 and 438) may begin generating route targets for exchanging routing information. The one or more network devices may execute the automated route target instructions 116 stored in the memory 114 to perform route target generation operations. In an implementation, a first network device in the new network fabric initiates the route target generation process, where the first network device may be the border gateway device 320A or the border gateway device 320B in the network fabric 330. In another implementation, the first network device may be the shared border gateway device 420 of the network fabrics 436 and 438. In step 504, the first network device may identify routing information to be shared with a first peer device. The first network device receives the routing information which may include, for example, MAC/IP routes (e.g., EVPN type 2 routes) and/or IP prefix routes (e.g., EVPN type 5 routes). In an implementation, the first peer device may be another network device in the new network fabric (e.g., another network device in the network fabric 330, or another network device in the network fabrics 436 or 438), or may be a network device in the existing network fabric (e.g., a network device in the network fabric 334, or a network device in the full mesh of network fabrics in portion 440). In an implementation, the first peer device may be a network device in the WAN portion 332. For example, in the network deployment 300, when MAC/IP routes for the host H1 are discovered by the leaf switch 310, the leaf switch 310 may publish these routes to the route reflectors RR1 and RR2. The route reflectors RR1 and RR2 may then publish these routes to the first network device (e.g., the border gateway device 320A or the border gateway device 320B). Similarly, in the network deployment 400, when MAC/IP routes or IP prefix routes need to be shared between the full mesh of network fabrics in portion 440 and the network fabrics 436 and 438, the leaf switches 422 and 424 may publish these routes to the route reflector RR11, or the leaf switches 426 and 428 may publish these routes to the route reflector RR12. The route reflectors RR11 and RR12 may then publish the routing information to the first network device (e.g., the shared border gateway device 420).

In step 506, the first network device may determine whether the VLAN associated with the routing information identified in the step 504 is configured with different VNIs for peer devices within the new network fabric versus peer devices outside the new network fabric. In an implementation, the first network device may check the VNI configurations for this VLAN to determine if different VNIs are used when communicating with peer devices within the new network fabric versus outside the new network fabric. For example, in the network deployment 300, when the first network device (e.g., the border gateway device 320A or 320B) receives routing information for a VLAN from the leaf switch 310 via the route reflectors RR1 and RR2, it may determine whether this VLAN uses one VNI for communicating with peer devices within the network fabric 330 and a different VNI for communicating with peer devices in the network fabric 334. Similarly, in the network deployment 400, when the first network device (e.g., the shared border gateway device 420) receives routing information for a VLAN from the leaf switches 422 and 424 via route reflector RR11 or from the leaf switches 426 and 428 via route reflector RR12, it may determine whether this VLAN uses one VNI for communicating with peer devices within the network fabrics 436 and 438 and a different VNI for communicating with peer devices in the full mesh of network fabrics in portion 440.

If it is determined in step 506 that the VLAN associated with the routing information identified in the step 504 is configured to use the same VNI when communicating with peer devices both within the new network fabric and outside the new network fabric, in step 508, the first network device may cross-check the AS configuration of the first peer device and obtain the AS number associated with the first peer device. For example, in the network deployment 300, when the first network device (e.g., the border gateway device 320A or 320B) needs to share routing information with the first peer device, wherein the first peer device is a peer device within the network fabric 330 (e.g., one of the route reflectors RR1 and RR2) or wherein the first peer device is a peer device outside the network fabric 330 (e.g., one of the border gateway devices 320C and 320D in the network fabric 334, or one of the route servers RS1 and RS2 in the WAN portion 332), the first network device may obtain the AS number (e.g., AS11, AS12, AS13 for peer devices within the network fabric 330, AS3 for peer devices in the network fabric 334, or, AS2 for peer devices in the WAN portion 332) associated with the first peer device. Similarly, in the network deployment 400, when the first network device (e.g., the shared border gateway device 420) needs to share routing information with the first peer device, wherein the first peer device is a peer device within the network fabrics 436 and 438 (e.g., one of the route reflectors RR11 and RR12) or wherein the first peer device is a peer device outside the network fabrics 436 and 438 (e.g., a network device in the full mesh of network fabrics in portion 440), the first network device may obtain the AS number (e.g., AS4 and AS5 for peer devices within the network fabrics 436 and 438, respectively, or a relevant AS number for peer devices in the full mesh of network fabrics in portion 440) associated with the first peer device.

In step 510, the first network device may generate a route target by combining the AS number of the first peer device obtained in step 508 with the VNI configured for the VLAN associated with the routing information identified in the step 504. In an implementation, the first network device may generate the route target as an 8-octet extended community attribute, comprising a 2-octet type field set to indicate a route target extended community, and a 6-octet value field in which the AS number is encoded in the first two bytes and the VNI in the remaining four bytes. The route target may be expressed in a format of [AS]:[VNI]. For example, in the network deployment 300, when the first network device is the border gateway device 320A or 320B, the first network device may combine the obtained AS number (e.g., AS11, AS12, AS13 for peer devices within the network fabric 330, AS3 for peer devices in the network fabric 334, or AS2 for peer devices in the WAN portion 332) of the first peer device with the VNI configured for the VLAN associated with the routing information identified in the step 504 to generate the route target. As an example, the VLAN may be configured with VNI 1000, and the generated route target would be AS11:1000 for a peer device having AS number AS11, or AS3:1000 for a peer device having AS number AS3. Similarly, in the network deployment 400, when the first network device is the shared border gateway device 420, the first network device may combine the obtained AS number (e.g., AS4 and AS5 for peer devices within the network fabrics 436 and 438, respectively, or a relevant AS number for peer devices in the full mesh of network fabrics in portion 440) of the first peer device with the VNI configured for the VLAN associated with the routing information identified in the step 504 to generate the route target. As an example, the VLAN may be configured with VNI 2000, and the generated route target would be AS4:2000 for a peer device having AS number AS4.

In step 512, the first network device may incorporate the route target generated previously in the step 510 into a BGP update message containing the routing information identified in the step 504. A BGP update message may be used to advertise feasible routes that share common path attributes to a BGP peer, or to withdraw multiple unfeasible routes from service. In an implementation, the first network device may incorporate the route target as an extended community attribute in the BGP update message, where the route target is encoded as an 8-octet quantity comprising a 2-octet type field and a 6-octet value field. The type field may be set to indicate a route target extended community, and the value field may contain the AS number and VNI from the generated route target. For example, in the network deployment 300, when the first network device is the border gateway device 320A or 320B, the first network device may incorporate the route target generated previously in the step 510 into a BGP update message containing the routing information (e.g., the MAC/IP routes or IP prefix routes) identified in the step 504 to be shared with the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, when the first network device is the shared border gateway device 420, the first network device may incorporate the route target generated previously in the step 510 into a BGP update message containing the routing information (e.g., the MAC/IP routes or IP prefix routes) identified in the step 504 to be shared with the first peer device (e.g., one of the route reflectors RR11 and RR12 within the network fabrics 436 and 438, or a network device in the full mesh of network fabrics in portion 440).

In step 514, the first network device may transmit the BGP update message from the step 512 to the first peer device. For example, in the network deployment 300, when the first network device is the border gateway device 320A or 320B, the first network device may transmit the BGP update message from the step 512 to the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, when the first network device is the shared border gateway device 420, the first network device may transmit the BGP update message from the step 512 to the first peer device (e.g., one of the route reflectors RR11 and RR12 within the network fabrics 436 and 438, or a network device in the full mesh of network fabrics in portion 440).

If it is determined in the step 506 that the VLAN associated with the routing information identified in the step 504 is configured to use different VNIs when communicating with peer devices within the new network fabric versus peer devices outside the new network fabric, in step 516, the first network device may determine whether the first peer device is within the new network fabric or outside the new network fabric, and identify a first VNI configured for peer devices within the new network fabric and a second VNI configured for peer devices outside the new network fabric. For example, in the network deployment 300, when the first network device is the border gateway device 320A or 320B, the first network device may determine whether the first peer device is within the network fabric 330 (e.g., one of the route reflectors RR1 and RR2) or outside the network fabric 330 (e.g., one of the border gateway devices 320C and 320D in the network fabric 334, or one of the route servers RS1 and RS2 in the WAN portion 332), and identify the first VNI for communicating with peer devices within the network fabric 330 and the second VNI for communicating with peer devices outside the network fabric 330. Similarly, in the network deployment 400, when the first network device is the shared border gateway device 420, the first network device may determine whether the first peer device is within the network fabrics 436 and 438 (e.g., one of the route reflectors RR11 and RR12) or outside the network fabrics 436 and 438 (e.g., a network device in the full mesh of network fabrics in portion 440), and identify the first VNI for communicating with peer devices within the network fabrics 436 and 438 and the second VNI for communicating with peer devices outside the network fabrics 436 and 438.

In step 518, the first network device may cross-check the AS configuration of the first peer device and obtain the AS number associated with the first peer device. For example, in the network deployment 300, when the first network device is the border gateway device 320A or 320B and the first peer device is within the network fabric 330 (e.g., one of the route reflectors RR1 and RR2), the first network device may obtain the AS number (e.g., AS11, AS12, AS13) associated with the first peer device, or when the first peer device is outside the network fabric 330 (e.g., one of the border gateway devices 320C and 320D in the network fabric 334, or one of the route servers RS1 and RS2 in the WAN portion 332), the first network device may obtain the AS number (e.g., AS3 for peer devices in the network fabric 334, or AS2 for peer devices in the WAN portion 332) associated with the first peer device. Similarly, in the network deployment 400, when the first network device is the shared border gateway device 420 and the first peer device is within the network fabrics 436 and 438 (e.g., one of the route reflectors RR11 and RR12), the first network device may obtain the AS number (e.g., AS4 and AS5 for peer devices within the network fabrics 436 and 438, respectively) associated with the first peer device, or when the first peer device is outside the network fabrics 436 and 438 (e.g., a network device in the full mesh of network fabrics in portion 440), the first network device may obtain a relevant AS number associated with the first peer device.

In step 520, the first network device may generate a route target by combining the AS number of the first peer device obtained in step 518 with either the first VNI or the second VNI identified in step 516, depending on whether the first peer device is within the new network fabric or outside the new network fabric. In an implementation, the first network device may generate the route target as an 8-octet extended community attribute, comprising a 2-octet type field set to indicate a route target extended community, and a 6-octet value field in which the AS number is encoded in the first two bytes and either the first VNI or the second VNI is encoded in the remaining four bytes. The route target may be expressed in a format of [AS]:[VNI]. For example, in the network deployment 300, when the first network device is the border gateway device 320A or 320B, the first network device may combine the obtained AS number (e.g., AS11, AS12, AS13 for peer devices within the network fabric 330, AS3 for peer devices in the network fabric 334, or AS2 for peer devices in the WAN portion 332) of the first peer device with either the first VNI (when the first peer device is within the network fabric 330) or the second VNI (when the first peer device is outside the network fabric 330) to generate the route target. As an example, the VLAN may be configured with VNI 1000 for peers within the network fabric 330 and VNI 2000 for peers outside the network fabric 330, and the generated route target would be AS11:1000 for a peer device having AS number AS11 within the network fabric 330, or AS3:2000 for a peer device having AS number AS3 outside the network fabric 330. Similarly, in the network deployment 400, when the first network device is the shared border gateway device 420, the first network device may combine the obtained AS number (e.g., AS4 and AS5 for peer devices within the network fabrics 436 and 438, respectively, or a relevant AS number for peer devices in the full mesh of network fabrics in portion 440) of the first peer device with either the first VNI (when the first peer device is within the network fabrics 436 and 438) or the second VNI (when the first peer device is outside the network fabrics 436 and 438) to generate the route target.

In step 522, the first network device may incorporate the route target generated previously in the step 520 into a BGP update message containing the routing information identified in the step 504. A BGP update message may be used to advertise feasible routes that share common path attributes to a BGP peer, or to withdraw multiple unfeasible routes from service. In an implementation, the first network device may incorporate the route target as an extended community attribute in the BGP update message, where the route target is encoded as an 8-octet quantity comprising a 2-octet type field and a 6-octet value field. The type field may be set to indicate a route target extended community, and the value field may contain the AS number and either the first VNI or second VNI from the generated route target. For example, in the network deployment 300, when the first network device is the border gateway device 320A or 320B, the first network device may incorporate the route target generated previously in the step 520 into a BGP update message containing the routing information (e.g., the MAC/IP routes or IP prefix routes) identified in the step 504 to be shared with the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, when the first network device is the shared border gateway device 420, the first network device may incorporate the route target generated previously in the step 520 into a BGP update message containing the routing information (e.g., the MAC/IP routes or IP prefix routes) identified in the step 504 to be shared with the first peer device (e.g., one of the route reflectors RR11 and RR12 within the network fabrics 436 and 438, or a network device in the full mesh of network fabrics in portion 440).

In step 524, the first network device may transmit the BGP update message from the step 522 to the first peer device. For example, in the network deployment 300, when the first network device is the border gateway device 320A or 320B, the first network device may transmit the BGP update message from the step 522 to the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, when the first network device is the shared border gateway device 420, the first network device may transmit the BGP update message from the step 522 to the first peer device (e.g., one of the route reflectors RR11 and RR12 within the network fabrics 436 and 438, or a network device in the full mesh of network fabrics in portion 440). After the step 514 or the step 524 is performed, the route target generation process is terminated, as marked by the step 526 of the flowchart 500.

In an implementation, the first network device may be configured to operate with BGP peer groups. A peer group may be a group of BGP peer devices that follow the same policies, route maps, and configurations. When network devices are configured as part of the same peer group, all policies, route maps, and configurations applied to this peer group are equally applicable to all peer devices in the group. For example, in the network deployment 300, the first network device may be one of the border gateway devices 320A and 320B, and the first network device may configure route reflectors RR1 and RR2 as one peer group, and the same route targets may then be generated for both the route reflectors RR1 and RR2. Similarly, in the network deployment 400, peer groups may be configured for network devices in the network fabrics 436 and 438. The first network device may generate route targets at the peer group level instead of individually for each peer device in the peer group. For example, when routing information needs to be shared with peer devices in a peer group, the first network device may identify whether different VNIs are configured for the VLAN associated with the routing information, obtain the AS number associated with all peer devices in the peer group, generate appropriate route targets by combining the AS number with the VNIs, and incorporate these route targets into BGP update messages that are then transmitted to all peer devices in that peer group.

In an implementation, the first network device may be configured to operate with dynamic peering. Dynamic peering may be a feature where BGP peer devices are discovered without knowing their configurations beforehand, and a range of potential AS numbers may be configured that the first network device may accept peering from. When configured for dynamic peering, the first network device may adjust route target generation based on the discovered peer device's AS configuration. For example, in the network deployment 300, the first network device may be one of the border gateway devices 320A and 320B, and the first network device may be configured with a range of potential AS numbers. The first network device may initially generate route targets by combining each AS number in the configured range with the VNIs configured for VLANs associated with routing information to be shared, and incorporate these route targets into BGP update messages. When a BGP session is established with the first peer device and the first peer device sends BGP update messages, the first network device may detect the AS number associated with the first peer device. The first network device may then dynamically regenerate route targets using the detected AS number for subsequent BGP update messages to the first peer device. In an implementation, if changes are detected in the AS configuration of the first peer device in subsequent BGP update messages, the first network device may automatically regenerate the route targets using the newly detected AS number.

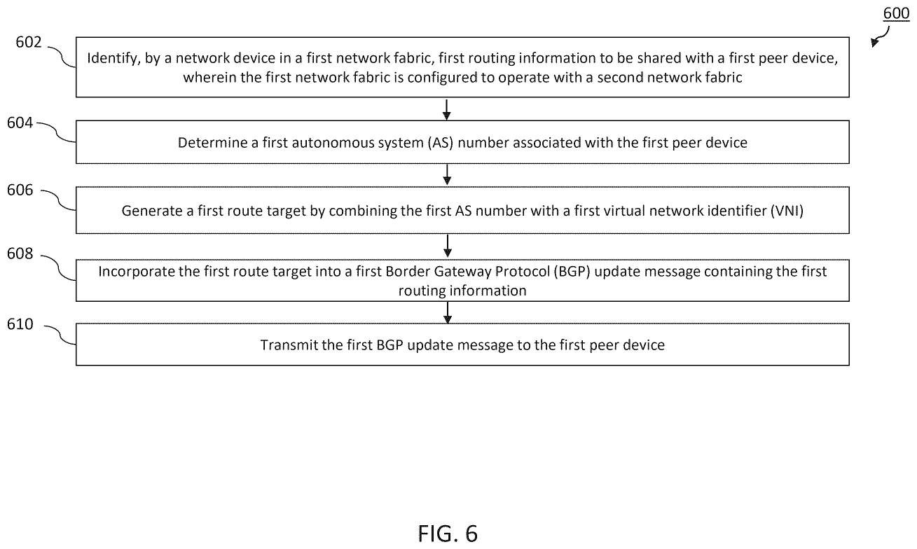

FIG. 6 illustrates an example method 600 for automatically generating and managing route targets in multi-fabric network deployments (e.g., the network deployment 300 and the network deployment 400). In an implementation, the method 600 may be performed by a network device (e.g., the first network device described previously in FIG. 5) to exchange routing information between network fabrics.

In step 602, first routing information to be shared with a first peer device is identified by a network device in a first network fabric, wherein the first network fabric is configured to operate with a second network fabric. For example, as described previously in step 504 of FIG. 5, in the network deployment 300, when MAC/IP routes for a host H1 are discovered by the leaf switch 310, the leaf switch 310 may publish these routes to the route reflectors RR1 and RR2, which may then publish the routes to the first network device (e.g., the border gateway device 320A or the border gateway device 320B). Similarly, as described previously in step 504 of FIG. 5, in the network deployment 400, when MAC/IP routes or IP prefix routes need to be shared between the full mesh of network fabrics in portion 440 and the network fabrics 436 and 438, the leaf switches 422 and 424 may publish these routes to the route reflector RR11, or the leaf switches 426 and 428 may publish these routes to the route reflector RR12, which may then publish the routing information to the first network device (e.g., the shared border gateway device 420).

In step 604, a first autonomous system (AS) number associated with the first peer device is determined. For example, as described previously in step 508 and step 518 of FIG. 5, in the network deployment 300, when the first network device (e.g., the border gateway device 320A or 320B) needs to share routing information with the first peer device, wherein the first peer device is a peer device within the network fabric 330 (e.g., one of the route reflectors RR1 and RR2) or wherein the first peer device is a peer device outside the network fabric 330 (e.g., one of the border gateway devices 320C and 320D in the network fabric 334, or one of the route servers RS1 and RS2 in the WAN portion 332), the first network device may obtain the AS number (e.g., AS11, AS12, AS13 for peer devices within the network fabric 330, AS3 for peer devices in the network fabric 334, or AS2 for peer devices in the WAN portion 332) associated with the first peer device. Similarly, as described previously in step 508 and 518 of FIG. 5, in the network deployment 400, when the first network device (e.g., the shared border gateway device 420) needs to share routing information with the first peer device, wherein the first peer device is a peer device within the network fabrics 436 and 438 (e.g., one of the route reflectors RR11 and RR12) or wherein the first peer device is a peer device outside the network fabrics 436 and 438 (e.g., a network device in the full mesh of network fabrics in portion 440), the first network device may obtain the AS number (e.g., AS4 and AS5 for peer devices within the network fabrics 436 and 438, respectively, or a relevant AS number for peer devices in the full mesh of network fabrics in portion 440) associated with the first peer device.

In step 606, a first route target is generated by combining the first AS number with a first virtual network identifier (VNI). For example, as described previously in step 510 of FIG. 5 when the VLAN is configured with the same VNI for peer devices both within the new network fabric and outside the new network fabric, or in step 520 of FIG. 5 when the VLAN is configured with different VNIs for peer devices within the new network fabric versus outside the new network fabric, the first network device may generate the route target by combining the AS number and VNI in a specific format of [AS]:[VNI]. In an example in which the same VNI is used for peer devices both within the new network fabric and outside the new network fabric, as described in step 510, the VLAN may be configured with VNI 1000, and the generated route target may be AS11:1000 for a peer device having AS number AS11 in the network fabric 330, or AS3:1000 for a peer device having AS number AS3 in the network fabric 334. In an example in which different VNIs are used for peer devices within the new network fabric versus outside the new network fabric, as described in step 520, the VLAN may be configured with VNI 1000 for peer devices within the new network fabric and VNI 2000 for peer devices outside the new network fabric, the generated route target may be AS11:1000 for a peer device having AS number AS11 within the network fabric 330 (e.g., the new network fabric), or AS3:2000 for a peer device having AS number AS3 in the network fabric 334 (e.g., the existing fabric).

In step 608, the first route target is incorporated into a first Border Gateway Protocol (BGP) update message containing the first routing information. As an example, in the network deployment 300, and as described in step 512 and step 522 of FIG. 5, when the first network device is the border gateway device 320A or 320B, the first network device may incorporate the route target generated previously in the step 510 or step 520 of FIG. 5 into a BGP update message containing the routing information (e.g., the MAC/IP routes or IP prefix routes) to be shared with the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, and as described in step 512 and step 522 of the FIG. 5, when the first network device is the shared border gateway device 420, the first network device may incorporate the route target generated previously in the step 510 or step 520 of FIG. 5 into a BGP update message containing the routing information (e.g., the MAC/IP routes or IP prefix routes) to be shared with the first peer device (e.g., one of the route reflectors RR11 and RR12 within the network fabrics 436 and 438, or a network device in the full mesh of network fabrics in portion 440).

In step 610, the first BGP update message is transmitted to the first peer device. For example, in the network deployment 300, when the first network device is the border gateway device 320A or 320B, the first network device may transmit the BGP update message from the step 512 or step 522 of FIG. 5 to the first peer device (e.g., one of the route reflectors RR1 and RR2 within the network fabric 330, one of the border gateway devices 320C and 320D in the network fabric 334, or one of the route servers RS1 and RS2 in the WAN portion 332) as described previously in the step 514 or 524 of FIG. 5. Similarly, in the network deployment 400, when the first network device is the shared border gateway device 420, the first network device may transmit the BGP update message from the step 512 or step 522 of FIG. 5 to the first peer device (e.g., one of the route reflectors RR11 and RR12 within the network fabrics 436 and 438, or a network device in the full mesh of network fabrics in portion 440) as described previously in the step 514 or 524 of FIG. 5.

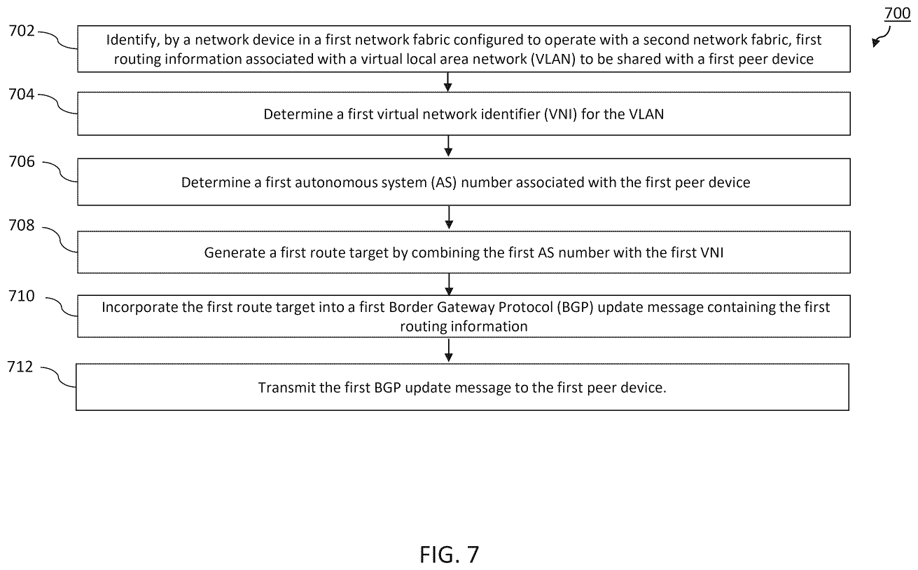

FIG. 7 illustrates an example method 700 for automatically generating and managing route targets in multi-fabric network deployments (e.g., the network deployment 300 and the network deployment 400). In an implementation, the method 700 may be performed by a network device (e.g., the first network device described previously in FIG. 5) to exchange routing information between network fabrics.

In step 702, first routing information associated with a virtual local area network (VLAN) to be shared with a first peer device is identified by a network device in a first network fabric, wherein the first network fabric is configured to operate with a second network fabric. For example, as described previously in step 504 of FIG. 5, in the network deployment 300, when MAC/IP routes for a host H1 are discovered by the leaf switch 310, the leaf switch 310 may publish these routes to the route reflectors RR1 and RR2, which may then publish the routes to the first network device (e.g., the border gateway device 320A or the border gateway device 320B). The routing information for host H1 may be associated with a specific VLAN that needs to be advertised across the network fabrics 330 and 334. Similarly, as described previously in step 504 of FIG. 5, in the network deployment 400, when MAC/IP routes or IP prefix routes need to be shared between the full mesh of network fabrics in portion 440 and the network fabrics 436 and 438, the leaf switches 422 and 424 may publish these routes to the route reflector RR11, or the leaf switches 426 and 428 may publish these routes to the route reflector RR12, which may then publish the routing information to the first network device (e.g., the shared border gateway device 420). The routing information in this case may be associated with the VLAN that needs to be advertised across the network fabrics 436, 438 and the full mesh of network fabrics in portion 440.

In step 704, a first virtual network identifier (VNI) for the VLAN is determined. For example, as described previously in step 506 and step 516 of FIG. 5, in the network deployment 300, when the first network device (e.g., the border gateway device 320A or 320B) receives routing information for the VLAN, it may determine whether the VLAN uses one VNI for communicating with peer devices within the network fabric 330 and a different VNI for communicating with peer devices in the network fabric 334, or whether the VLAN is configured with a single VNI for communicating with peer devices in both the network fabric 330 and the network fabric 334. When different VNIs are configured, the first network device may determine whether the first peer device is within the network fabric 330 or outside the network fabric 330, and identify a first VNI for communicating with peer devices within the network fabric 330 and a second VNI for communicating with peer devices outside the network fabric 330. Similarly, in the network deployment 400, when the first network device (e.g., the shared border gateway device 420) receives routing information for the VLAN, it may determine whether the VLAN uses one VNI for communicating with peer devices within the network fabrics 436 and 438 and a different VNI for communicating with peer devices in the full mesh of network fabrics in portion 440, or whether the VLAN is configured with a single VNI for communicating with peer devices in the network fabrics 436 and 438 and the full mesh of network fabrics in portion 440. When different VNIs are configured, the first network device may determine whether the first peer device is within the network fabrics 436 and 438 or outside the network fabrics 436 and 438, and identify a first VNI for communicating with peer devices within the network fabrics 436 and 438 and a second VNI for communicating with peer devices outside the network fabrics 436 and 438.

In step 706, a first autonomous system (AS) number associated with the first peer device is determined. For example, as described previously in step 508 and step 518 of FIG. 5, in the network deployment 300, when the first network device (e.g., the border gateway device 320A or 320B) needs to share routing information with the first peer device, wherein the first peer device is a peer device within the network fabric 330 (e.g., one of the route reflectors RR1 and RR2) or wherein the first peer device is a peer device outside the network fabric 330 (e.g., one of the border gateway devices 320C and 320D in the network fabric 334, or one of the route servers RS1 and RS2 in the WAN portion 332), the first network device may obtain the AS number (e.g., AS11, AS12, AS13 for peer devices within the network fabric 330, AS3 for peer devices in the network fabric 334, or AS2 for peer devices in the WAN portion 332) associated with the first peer device. Similarly, as described previously in step 508 and 518 of FIG. 5, in the network deployment 400, when the first network device (e.g., the shared border gateway device 420) needs to share routing information with the first peer device, wherein the first peer device is a peer device within the network fabrics 436 and 438 (e.g., one of the route reflectors RR11 and RR12) or wherein the first peer device is a peer device outside the network fabrics 436 and 438 (e.g., a network device in the full mesh of network fabrics in portion 440), the first network device may obtain the AS number (e.g., AS4 and AS5 for peer devices within the network fabrics 436 and 438, respectively, or a relevant AS number for peer devices in the full mesh of network fabrics in portion 440) associated with the first peer device.

In step 708, a first route target is generated by combining the first AS number with the first VNI. For example, as described previously in step 510 of FIG. 5 when the VLAN is configured with the same VNI for peer devices both within the new network fabric and outside the new network fabric, or in step 520 of FIG. 5 when the VLAN is configured with different VNIs for peer devices within the new network fabric versus outside the new network fabric, the first network device may generate the route target by combining the AS number and VNI in a specific format of [AS]:[VNI]. In an example in which the same VNI is used for peer devices both within the new network fabric and outside the new network fabric, as described in step 510, the VLAN may be configured with VNI 1000, and the generated route target may be AS11:1000 for a peer device having AS number AS11 in the network fabric 330, or AS3:1000 for a peer device having AS number AS3 in the network fabric 334. In an example in which different VNIs are used for peer devices within the new network fabric versus outside the new network fabric, as described in step 520, the VLAN may be configured with VNI 1000 for peer devices within the new network fabric and VNI 2000 for peer devices outside the new network fabric, the generated route target may be AS11:1000 for a peer device having AS number AS11 within the network fabric 330 (e.g., the new network fabric), or AS3:2000 for a peer device having AS number AS3 in the network fabric 334 (e.g., the existing fabric).

In step 710, the first route target is incorporated into a first Border Gateway Protocol (BGP) update message containing the first routing information. As an example, in the network deployment 300, as described previously in step 512 and step 522, when the first network device is the border gateway device 320A or 320B, the first network device may incorporate the route target generated previously in the step 510 or step 520 of FIG. 5 into a BGP update message containing the routing information (e.g., the MAC/IP routes or IP prefix routes) to be shared with the first peer device (e.g., one of the route reflectors RR1 and RR2 within the network fabric 330, one of the border gateway devices 320C and 320D in the network fabric 334, or one of the route servers RS1 and RS2 in the WAN portion 332). Similarly, in the network deployment 400, as described previously in step 512 and step 522, when the first network device is the shared border gateway device 420, the first network device may incorporate the route target generated previously in the step 510 or step 520 of FIG. 5 into a BGP update message containing the routing information (e.g., the MAC/IP routes or IP prefix routes) to be shared with the first peer device (e.g., one of the route reflectors RR11 and RR12 within the network fabrics 436 and 438, or a network device in the full mesh of network fabrics in portion 440).

In step 712, the first BGP update message is transmitted to the first peer device. For example, in the network deployment 300, when the first network device is the border gateway device 320A or 320B, the first network device may transmit the BGP update message from the step 512 or step 522 to the first peer device (e.g., one of the route reflectors RR1 and RR2 within the network fabric 330, one of the border gateway devices 320C and 320D in the network fabric 334, or one of the route servers RS1 and RS2 in the WAN portion 332) as described previously in the step 514 or 524. Similarly, in the network deployment 400, when the first network device is the shared border gateway device 420, the first network device may transmit the BGP update message from the step 512 or step 522 to the first peer device (e.g., one of the route reflectors RR11 and RR12 within the network fabrics 436 and 438, or a network device in the full mesh of network fabrics in portion 440) as described previously in the step 514 or 524.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A network device in a first network fabric, the network device comprising:
a network adapter configured to communicate with peer devices in the first network fabric and a second network fabric;
at least one processing resource;
at least one non-transitory machine-readable storage medium storing instructions that when executed by the at least one processing resource cause the network device to:
identify first routing information to be shared with a first peer device;
determine a first autonomous system (AS) number associated with the first peer device;
generate a first route target by combining the first AS number with a first virtual network identifier (VNI);
incorporate the first route target into a first Border Gateway Protocol (BGP) update message containing the first routing information; and
transmit the first BGP update message to the first peer device.

2. The network device of claim 1, wherein the network device is configured to function as a border gateway device, a route reflector, or a route server.

3. The network device of claim 1, wherein the first peer device is in the first network fabric or the second network fabric.

4. The network device of claim 1, wherein the network device is configured to function as a shared border gateway device between the first network fabric and the second network fabric.

5. The network device of claim 1, wherein the instructions further cause the network device to:
identify second routing information to be shared with a second peer device;
determine a second autonomous system (AS) number associated with the second peer device;
generate a second route target by combining the second AS number with a second VNI;
incorporate the second route target into a second BGP update message containing the second routing information;
and transmit the second BGP update message to the second peer device.

6. The network device of claim 5, wherein the first VNI and the second VNI are different VNIs configured for a same virtual local area network (VLAN).

7. The network device of claim 1, wherein the first network fabric is an addition to an existing deployment comprising the second network fabric.

8. The network device of claim 7, wherein the network device operates with a first operating system, and network devices in the second network fabric operate with operating systems different from the first operating system.

9. A method comprising:
identifying, by a network device in a first network fabric, first routing information to be shared with a first peer device, wherein the first network fabric is configured to operate with a second network fabric;
determining a first autonomous system (AS) number associated with the first peer device;
generating a first route target by combining the first AS number with a first virtual network identifier (VNI);
incorporating the first route target into a first Border Gateway Protocol (BGP) update message containing the first routing information; and
transmitting the first BGP update message to the first peer device.

10. The method of claim 9, wherein the network device is configured to function as a border gateway device, a route reflector, or a route server.

11. The method of claim 9, further comprising:
identifying, by the network device, second routing information to be shared with a second peer device;
determining a second AS number associated with the second peer device;
generating a second route target by combining the second AS number with a second VNI;
incorporating the second route target into a second BGP update message containing the second routing information; and
transmitting the second BGP update message to the second peer device.

12. The method of claim 11, wherein the first VNI and the second VNI are different VNIs configured for a same virtual local area network (VLAN).

13. The method of claim 9, wherein generating the first route target by combining the first AS number with the first VNI comprises:
generating an 8-octet extended community attribute comprising a 2-octet type field set to indicate a route target extended community, and a 6-octet value field in which the first AS number is encoded in two bytes and the first VNI is encoded in four bytes.

14. The method of claim 9, wherein incorporating the first route target into the first BGP update message comprises incorporating the first route target as an extended community attribute in the first BGP update message.

15. A method comprising:
identifying, by a network device in a first network fabric configured to operate with a second network fabric, first routing information associated with a virtual local area network (VLAN) to be shared with a first peer device;
determining a first virtual network identifier (VNI) for the VLAN;
determining a first autonomous system (AS) number associated with the first peer device;
generating a first route target by combining the first AS number with the first VNI;
incorporating the first route target into a first Border Gateway Protocol (BGP) update message containing the first routing information; and
transmitting the first BGP update message to the first peer device.

16. The method of claim 15, further comprising:
identifying second routing information associated with the VLAN to be shared with a second peer device;
determining a second VNI for the VLAN;
determining a second AS number associated with the second peer device;
generating a second route target by combining the second AS number with the second VNI;
incorporating the second route target into a second BGP update message containing the second routing information; and
transmitting the second BGP update message to the second peer device.

17. The method of claim 16, wherein the first VNI is configured for peer devices within the first network fabric and the second VNI is configured for peer devices outside the first network fabric.

18. The method of claim 17, wherein the network device operates with a first operating system, and network devices in the second network fabric operate with operating systems different from the first operating system.

19. The method of claim 15, wherein generating the first route target by combining the first AS number with the first VNI comprises:
generating an 8-octet extended community attribute comprising a 2-octet type field set to indicate a route target extended community, and a 6-octet value field in which the first AS number is encoded in two bytes and the first VNI is encoded in four bytes.

20. The method of claim 15, wherein the first network fabric is an addition to an existing deployment comprising the second network fabric.
